(19) United States
(12) Patent Application Publication
(10) Pub. No.: US 2025/0070451 A1
(43) Pub. Date: Feb. 27, 2025

(54) ANTENNA DEVICE, HOUSING AND ELECTRONIC APPARATUS

(71) Applicants: Yungu (Gu’an) Technology Co., Ltd., Langfang (CN); Hefei Visionox Technology Co., Ltd., Hefei (CN)

(72) Inventors: Huan-Chu HUANG, Taoyuan City (CN); Jie WU, Langfang (CN); Shuang CUI, Langfang (CN)

(73) Assignees: Yungu (Gu’an) Technology Co., Ltd., Langfang (CN); Hefei Visionox Technology Co., Ltd., Hefei (CN)

(21) Appl. No.: 18/945,859

(22) Filed: Nov. 13, 2024

(30) Foreign Application Priority Data
Nov. 17, 2023 (CN) 202311542540.8

(51) Int. Cl. H01Q 1/22; H01Q 1/50; H01Q 21/06

(52) U.S. Cl. CPC H01Q 1/2283; H01Q 1/50; H01Q 21/06

(57) ABSTRACT

An antenna device, a housing and an electronic apparatus, the antenna device includes: a substrate, with a first section and a second section; an antenna module, provided in the first section and having two or more antenna units spaced apart on the first section; an integrated circuit, provided in the second section; a connecting portion, provided in the substrate and electrically connected the antenna unit and the integrated circuit; a metal shielding layer, provided in the substrate, and an orthographic projection of the plurality of antenna units in a thickness direction of the first section are located within an orthographic projection of the metal shielding layer in the thickness direction.

### CROSS-REFERENCE TO RELATED APPLICATION

The present application claims priority to Chinese Patent Application No. 202311542540.8 filed on Nov. 17, 2023, and titled “ANTENNA DEVICE, HOUSING AND ELECTRONIC DEVICE”, which is incorporated herein by reference in its entirety.

### TECHNICAL FIELD

The present application relates to the technical field of electronic equipment, and in particular to an antenna device, a housing and an electronic apparatus.

### BACKGROUND

The functions of wireless communication devices (such as mobile phones, smart watches, etc.) are changing rapidly, and the market requirements for device appearance and wireless communication performance are also increasing. How to improve the communication performance of electronic apparatus has become a technical problem that needs to be solved urgently.

### SUMMARY

Embodiments of the present application provide an antenna device, a housing, and an electronic apparatus, which are aimed at improving the wireless communication performance of the antenna device.

Some embodiments of a first aspect of the present application provide an antenna device, comprising: a substrate, comprising a first section and a second section; an antenna module, provided in the first section and comprising two or more antenna units distributed at intervals on the first section; an integrated circuit, provided in the second section; a connecting portion, provided on the substrate and electrically connecting the antenna unit and the integrated circuit; a metal shielding layer, provided on the substrate, and an orthographic projection of a plurality of antenna units in a thickness direction of the first section are located within an orthographic projection of the metal shielding layer in the thickness direction.

An embodiment of the second aspect of the present application provides a housing of an electronic apparatus, the electronic apparatus comprises an antenna device, the antenna device comprises a plurality of antenna units, the housing comprises: a frame body, enclosing to form a hollow space and comprising a segmented portion, wherein the segmented portion comprises a clearance hole that is provided penetrating through the segmented portion, and the clearance hole is configured to provide clearance for the plurality of antenna units.

An embodiment of a third aspect of the present application provides an electronic apparatus, comprising the antenna device of any of the first aspect embodiments and the housing of any of the second aspect embodiments, wherein ab orthographic projection of at least one of the antenna units along a thickness direction is located within an orthographic projection of the clearance hole along the thickness direction.

In an antenna device provided in the present application, the antenna device comprises a substrate, an antenna module, an integrated circuit, a connector and a metal shielding layer. A first section of the substrate is configured to carry the antenna unit of the antenna module, the second section of the substrate is configured to carry the integrated circuit, and the connecting section connects the integrated circuit and the antenna unit, so that the integrated circuit can send a control signal to the antenna unit. The metal shielding layer is provided on the substrate, and an orthographic projection of the plurality of antenna units in a thickness direction of the first section is located within an orthographic projection of the metal shielding layer in the thickness direction. In one respect, the metal shielding layer can improve a transmission of a signal sent by the antenna unit to the inside of the antenna device, affecting its internal signal transmission. Besides the metal shielding layer can reflect the signal out of the antenna device, thereby improving a wireless signal communication performance of the antenna device.

### BRIEF DESCRIPTION OF THE DRAWINGS

Other features, objects and advantages of the present application will become more apparent by reading the following detailed description of non-limiting embodiments with reference to the accompanying drawings, in which the same or similar reference numerals represent the same or similar features.

FIG. 1 is a schematic structural diagram of an antenna device provided by an embodiment of the present application;

FIG. 2 is a schematic structural diagram of the antenna device shown in FIG. 1 from another viewing angle;

FIG. 3 is a schematic structural diagram of an antenna device provided by another embodiment of the present application;

FIG. 4 is a schematic structural diagram of the antenna device shown in FIG. 3 from another viewing angle;

FIG. 5 is a schematic structural diagram of an antenna device provided by another embodiment of the present application;

FIG. 6 is a schematic structural diagram of the antenna device shown in FIG. 5 from another viewing angle;

FIG. 7 is a schematic structural diagram of an antenna device provided by another embodiment of the present application;

FIG. 8 is a schematic structural diagram of the antenna device shown in FIG. 7 from another viewing angle;

FIG. 9 is a schematic structural diagram of an antenna device provided in another embodiment of the present application;

FIG. 10 is a schematic structural diagram of a housing provided by an embodiment of the present application;

FIG. 11 is a partially enlarged schematic structural diagram of a segmented portion of a housing provided by an embodiment of the present application;

FIG. 12 is a schematic structural diagram in which an antenna device is provided on a segmented portion of the housing shown in FIG. 11;

FIG. 13 is a schematic diagram of the structure shown in FIG. 12 from another viewing angle;

FIG. 14 is a partially enlarged schematic structural diagram of a segmented portion of a housing provided by another embodiment of the present application;

FIG. 15 is a schematic diagram of the structure shown in FIG. 14 from another viewing angle;

FIG. 16 is a schematic structural diagram of an antenna device provided on a segmented portion of the housing shown in FIG. 14;

FIG. 17 is a partial enlarged structural schematic diagram of a segmented portion of a housing provided by another embodiment of the present application;

FIG. 18 is a schematic diagram of the structure shown in FIG. 17 from another viewing angle;

FIG. 19 is a schematic structural diagram of an antenna device provided on a segmented portion of the housing shown in FIG. 17;

FIG. 20 is a schematic diagram of the structure shown in FIG. 19 from another viewing angle;

FIG. 21 is a partial enlarged structural schematic diagram of a segmented portion of a housing provided by another embodiment of the present application;

FIG. 22 is a schematic diagram of the structure shown in FIG. 21 from another viewing angle;

FIG. 23 is a top view of a segmented portion of the housing shown in FIG. 21;

FIG. 24 is a partial enlarged structural schematic diagram of a segmented portion of a housing provided by another embodiment of the present application;

FIG. 25 is a schematic diagram of the structure shown in FIG. 24 from another viewing angle;

FIG. 26 is a schematic structural diagram of an antenna device provided on a segmented portion of the housing shown in FIG. 24;

FIG. 27 is a schematic diagram of the structure shown in FIG. 26 from another viewing angle.

### DESCRIPTION OF REFERENCE NUMERALS

10. antenna device; 20. housing;
100. substrate; 110. first section; 120. second section; 130. bent portion; 140. conductive isolation portion; 141. first isolation portion;
200. antenna module; 210. antenna unit;
300. integrated circuit;
400. connecting portion; 410. first segment; 420. second segment;
500. frame body; 501. segmented portion; 502. hollow space; 510. inner surface; 520. outer surface; 530. first groove; 531. first bottom wall surface; 532. first side wall surface; 533. clearance hole; 540. channel; 550. side surface; 551. first side surface; 552. second side surface; 560. second groove; 561. second bottom wall surface; 562. second side wall surface;
600. connector;
700. decorative cover;
800. metal shielding layer;
Y first direction; X. second direction; Z. third direction.

### DETAILED DESCRIPTION

Features and exemplary embodiments of various aspects of the present application will be described in detail below. In the detailed description below, many specific details are proposed to provide a comprehensive understanding of the present application. However, it is obvious to those skilled in the art that the present application can be implemented with no need for some of these specific details. The following description of the embodiments is only intended to provide a better understanding of the present application by illustrating examples of the present application. In the accompanying drawings and the following description, at least part of the known structures and technologies are not shown to avoid unnecessary obscuring the present application, and for clarity, the size of some structures may be exaggerated. In addition, features, structures or characteristics described below may be combined in one or more embodiments in any suitable manner.

In the description of the present application, it should be noted that, unless otherwise specified, “the plurality of” means more than two; the directions or positional relationships indicated by the terms “upper”, “lower”, “left”, “right”, “inner”, “outer”, etc. are only for the convenience of describing the present application and simplifying the description, and do not indicate or imply that the device or element referred to must have a specific direction, be constructed or operated in a specific direction, and therefore cannot be understood as limiting the present application. In addition, the terms “first”, “second”, etc. are only used for descriptive purposes and cannot be understood as indicating or implying relative importance.

Directional words appearing in the following description are all directions shown in the figures, and do not limit the specific structure of the embodiments of the present application. In the description of the present application, it should also be noted that, unless otherwise clearly specified and limited, the terms “installation” and “connection” should be understood in a broad sense, for example, it can be a fixed connection, a detachable connection, or an integral connection; it can be directly connected or indirectly connected. For ordinary skilled in the field, the specific meanings of the above terms in this application can be understood according to the specific circumstances.

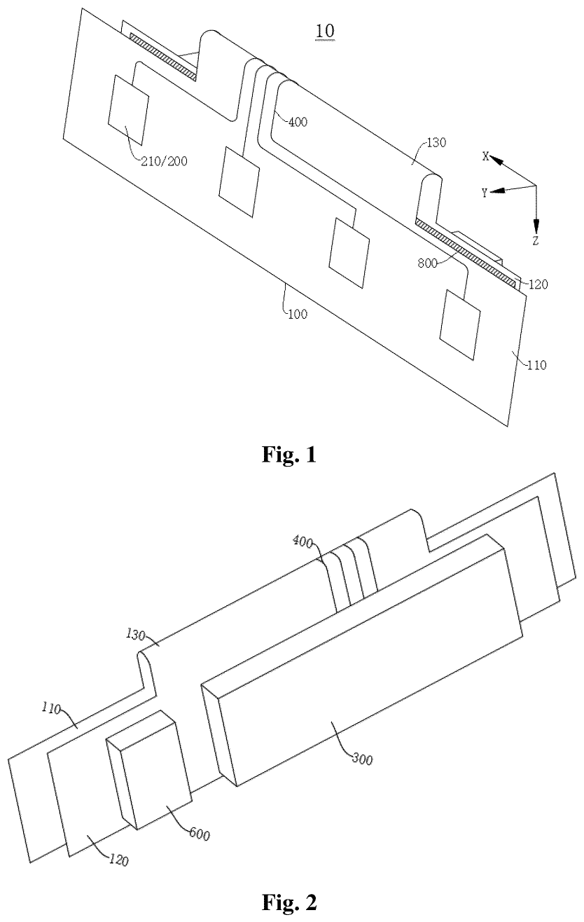

In order to better understand the present application, an antenna device 10, a housing 20 and an electronic apparatus according to embodiments of the present application are described in detail below in conjunction with FIGS. 1 and 27.

Please refer to FIGS. 1 and 2 together, FIG. 1 is a structural schematic diagram of an antenna device 10 provided by an embodiment of a first aspect of the present application; FIG. 2 is a structural schematic diagram of the antenna device 10 provided by an embodiment of the first aspect of the present application from another viewing angle.

As shown in FIG. 1 and FIG. 2, an embodiment of the first aspect of the present application provides an antenna device 10. The antenna device 10 comprises a substrate 100, an antenna module 200, an integrated circuit 300, a connector 600, and a metal shielding layer 800. The substrate 100 comprises a first section 110 and a second section 120; the antenna module 200 is provided in the first section 110 and comprises two or more antenna units 210 spaced apart on the first section 110; the integrated circuit 300 is provided in the second section 120; the connecting portion 400 is provided in the substrate 100 and electrically connects the antenna unit 210 and the integrated circuit 300; the metal shielding layer 800 is provided in the substrate 100, and an orthographic projection of the plurality of antenna units 210 in a thickness direction of the first section 110 is located within an orthographic projection of the metal shielding layer 800 in the thickness direction.

In an antenna device 10 provided in the present application, the antenna device 10 comprises a substrate 100, an antenna module 200, an integrated circuit 300, a connector 600 and a metal shielding layer 800. The first section 110 of the substrate 100 is configured to carry the antenna unit 210 of the antenna module 200, the second section 120 of the substrate 100 is configured to carry the integrated circuit 300, and the connecting portion 400 connects the integrated circuit 300 and the antenna unit 210, so that the integrated circuit 300 can send a control signal to the antenna unit 210. The metal shielding layer 800 is provided on the substrate 100, and the orthographic projection of the plurality of antenna units 210 in the thickness direction of the first section 110 is located within the orthographic projection of the metal shielding layer 800 in the thickness direction. In one respect, the metal shielding layer 800 can improve the transmission of a signal sent by the antenna unit 210 to the inside of the antenna device 10, affecting its internal signal transmission. Besides the metal shielding layer 800 can reflect the signal out of the antenna device 10, thereby improving the wireless signal communication performance of the antenna device 10.

Alternatively, the integrated circuit 300 may comprise a radio frequency integrated circuit and a battery management integrated circuit, the radio frequency integrated circuit is connected with the antenna unit 210 to transmit a radio frequency signal to the antenna unit 210. Alternatively, the integrated circuit 300 may comprise only a radio frequency integrated circuit.

There are many ways to provide the substrate 100. For example, the substrate 100 can be a rigid substrate 100, which can be a structure such as glass or steel plate. Alternatively, the material of the substrate 100 comprises a flexible material such as polyimide, which allows the substrate 100 to readily change its shape according to the installation position, thereby simplifying the installation difficulty of the antenna device 10.

The first section 110 and the second section 120 on the substrate 100 can be provided integrally or separately, and the first section 110 and the second section 120 can be provided in a stacked manner or distributed in sequence along a same direction. As an optional embodiment, as shown in FIG. 1 and FIG. 2, the substrate 100 further comprises a bent portion 130, which is deformed to be bent and connects the first section 110 and the second section 120. The first section 110 and the second section 120 are provided at intervals along the thickness direction. The substrate 100 is generally U-shaped, so that the substrate 100 can break through metal shielding, for example, the antenna device 10 can be provided on a frame of an electronic apparatus, so that the substrate 100 covers an inner surface and an outer surface of the frame respectively and breaks through the metal shielding. And it can be ensured that a distance between the antenna unit 210 and the integrated circuit 300 is closer, so that the intermediate loss is minimized, thereby improving the performance of the antenna device 10 and the quality of wireless communication of the antenna device of the electronic apparatus.

There are many ways to provide the antenna unit 210. Optionally, the antenna unit 210 can be configured to send and receive millimeter wave antenna signals. The antenna unit 210 can be formed by cutting a grid-like metal wiring. Alternatively, the material of the antenna unit 210 comprises a light-transmitting conductive material such as indium tin oxide to improve the light transmittance of the antenna unit 210. More than two antenna units 210 of the antenna module 200 can be provided independently with each other, or more than two antenna units 210 can be electrically connected with each other through a connecting line.

There are many ways to provide the connecting portion 400. The connecting portion 400 is configured to connect the signal line and electrically connect the antenna unit 210 and the integrated circuit 300. A shape of the connecting portion 400 can be changed according to the positions of the antenna unit 210 and the integrated circuit 300. As mentioned above, when the substrate 100 comprises the bent portion 130, the connecting portion 400 can electrically connect the antenna unit 210 and the integrated circuit 300 via the bent portion 130.

Alternatively, the metal shielding layer 800 may be formed by coating the substrate 100 with a metal material.

In some embodiments, as described above, the first section 110 and the second section 120 may be spaced apart in the thickness direction of the first section 110, and the metal shielding layer 800 may be provided on the second section 120. Therefore, a distance between the antenna unit 210 on the first section 110 and the metal shielding layer 800 is increased, thereby improving the wireless signal transmission performance of the antenna unit 210.

There are many ways to provide the position of the metal shielding layer 800 on the second section 120. The metal shielding layer 800 can be provided on a surface of the second section 120 facing or away from the first section 110. The metal shielding layer 800 and the integrated circuit 300 can be provide on a same surface of the second section 120. Or, alternatively, the metal shielding layer 800 and the integrated circuit 300 are separately provide on two surfaces of the second section 120 opposite to each other in the thickness direction, so that projections of the metal shielding layer 800 and the integrated circuit 300 in the thickness direction can overlap, so that the metal shielding layer 800 and the integrated circuit 300 can be provide on the second section 120 of smaller size at the same time, thereby reducing the overall volume of the antenna device 10.

Alternatively, the metal shielding layer 800 is provided on a surface of the second section 120 facing the first section 110, and the integrated circuit 300 is provided on a surface of the second section 120 away from the first section 110. So that the integrated circuit 300 can be exposed to facilitate the electrical connection between the integrated circuit 300 and the antenna unit 210.

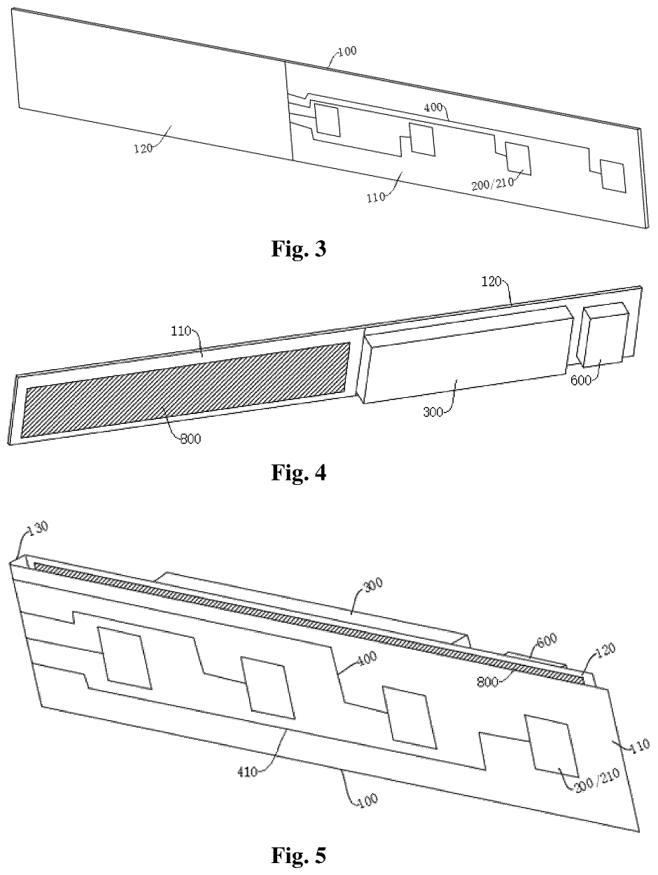

In other embodiments, as shown in FIG. 3 and FIG. 4, the first section 110 and the second section 120 are sequentially distributed along the length direction of the first section 110, and the metal shielding layer 800 is provided in the first section 110.

In these embodiments, the first section 110 and the second section 120 are provided side by side in sequence, and the metal shielding layer 800 and the antenna unit 210 are both provided in the first section 110, so that projections of the metal shielding layer 800 and the antenna unit 210 along the thickness direction of the first section 110 can overlap.

Alternatively, the antenna unit 210 and the metal shielding layer 800 are provided on two opposite surfaces of the first section 110 in the thickness direction to increase the distance between the metal shielding layer 800 and the antenna unit 210 and improve the performance of the antenna unit 210 in transmitting wireless signals.

Alternatively, as shown in FIGS. 1 and 2, and FIGS. 5 to 8, the substrate 100 may further comprise a bent portion 130 connecting the first section 110 and the second section 120, the first section 110, the second section 120 and the bent portion 130 are integrally provided, one end of the connecting portion 400 is connected with the antenna unit 210, and the other end extends to the integrated circuit 300 via the bent portion 130 to electrically connect the antenna unit 210 and the integrated circuit 300. The connecting portion 400 is connected between the antenna unit 210 and the integrated circuit 300 via the bent portion 130 to realize transmission of signals between the integrated circuit 300 and the antenna unit 210.

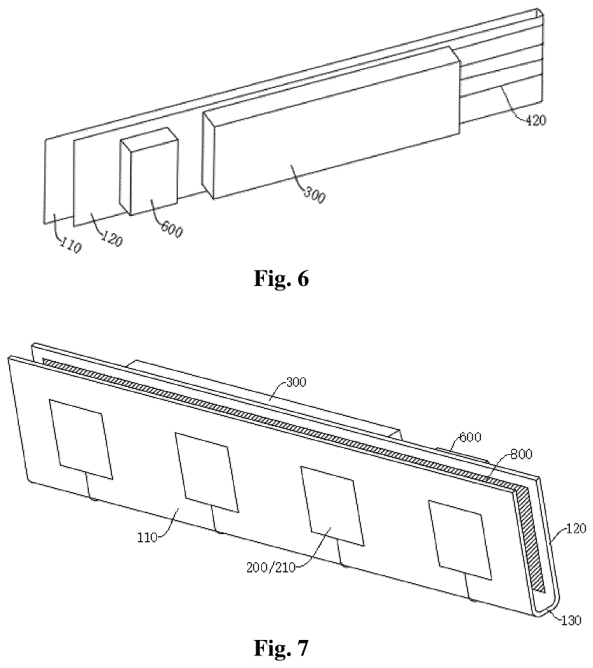

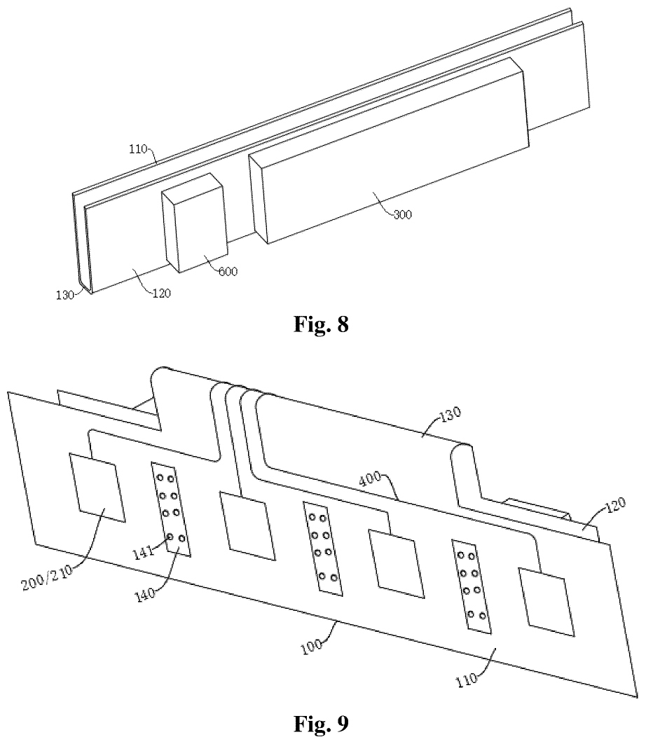

There are many positions for providing the bent portion 130. As shown in FIGS. 1 and 2, the bent portion 130 can be provided on a side of the first section 110 in a width direction. Alternatively, as shown in FIGS. 5 and 6, the bent portion 130 can be provided on a side of the first section 110 in the second direction X. The size of the bent portion 130 can be the same as or different from the size of the first section 110. As shown in FIGS. 1 and 2, the bent portion 130 is provided on a side of the first section 110 in the third direction Z, and the length of the bent portion 130 is less than the length of the first section 110. Alternatively, as shown in FIGS. 7 and 8, the length of the bent portion 130 is equal to the length of the first section 110.

In other embodiments, the first section 110 and the second section 120 can be separately provided, and the connecting portion 400 comprises a first segment 410 provided in the first section 110 and electrically connected with the antenna unit 210, and a second segment 420 provided in the second section 120 and electrically connected with the integrated circuit 300. The first segment 410 and the second segment 420 are bound and connected, which can increase the freedom of material selection, so as to reduce the size of the antenna module 200, reduce the cost, and improve the reliability of the performance of the line module 200. Or the first segment 410 and the second segment 420 are electrically connected with each other by means of a connector. For example, the first segment 410 and the second segment 420 are connected with each other by plugging in through a plug connector, which is convenient for maintenance and replacement.

In some optional embodiments, as shown in FIG. 9, the antenna device 10 further comprises a conductive isolation portion 140, which is provided in the first section 110 and between two adjacent antenna units 210. The conductive isolation portion 140 can be provided to increase the isolation between two adjacent antenna units 210 and improve the performance of the antenna unit 210.

Optionally, the conductive isolation portion 140 may be provided on the surface of the first section 110, or the conductive isolation portion 140 may be provided in the first section 110. As long as the conductive isolation portion 140 is located between two adjacent antenna units 210, it will suffice.

Optionally, the conductive isolation portion 140 comprises a first isolation portion 141 provided on the surface of the first section 110 and a second isolation portion 142 provided in the first section 110. The first isolation portion 141 and the second isolation portion 142 are connected with each other. By providing the first isolation portion 141 located on the surface of the first section 110 and the second isolation portion 142 located in the first section 110, isolation between adjacent antenna units 210 can be increased, and the problem of signal interference between two adjacent antenna units 210 can be better improved.

Alternatively, surfaces of the first section 110 facing toward and away from the second section 120 are both provided with a first conductive isolation portion 141, that is, the first isolation portion 141 is provided on two opposite surfaces of the first section 110, and the second isolation portion 142 is connected with the first isolation portion 141 located on two opposite surfaces of the first section 110, thereby further increasing the isolation between adjacent antenna units 210, better improving the problem of antenna mutual coupling between two adjacent antenna units 210, and thereby improving the performance of wireless communication.

Optionally, when the antenna module 200 is provided in the housing of the electronic apparatus, the first conductive isolation portion 141 of the first section 110 facing the surface of the second section 120 can be in contact and connected with the frame of the housing to better improve the problem of antenna mutual coupling between two adjacent antenna units 210, thereby improving the performance of wireless communication.

In any of the above embodiments, there are many ways to provide the antenna module 200. The antenna module 200 can be configured to send and receive wireless signals of various frequency bands; for example, the wireless module is configured to send and receive millimeter wave wireless signals.

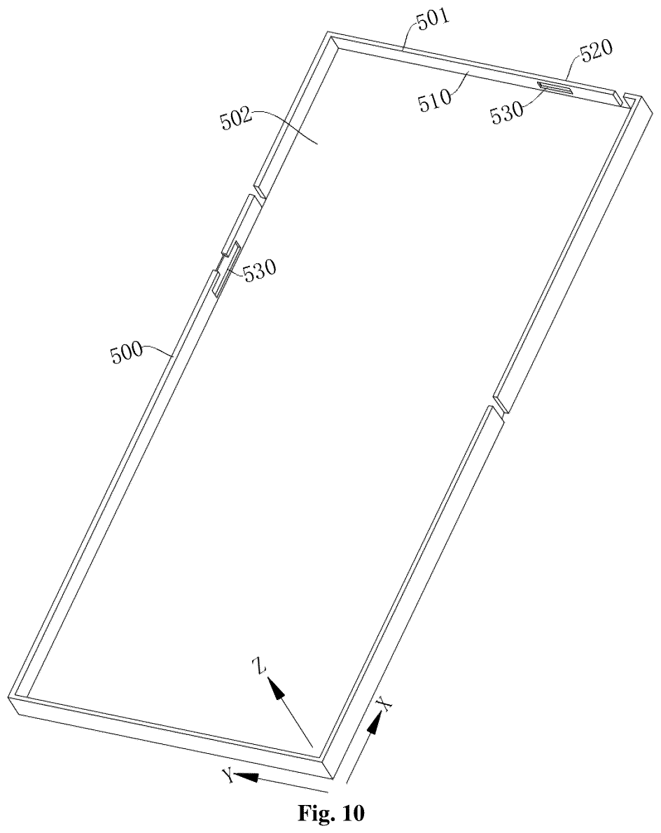

As shown in FIGS. 10 to 13, an embodiment of the second aspect of the present application further provides a housing 20 of an electronic apparatus, the electronic apparatus comprises an antenna device 10, and the antenna device 10 comprises a plurality of antenna units 210. Alternatively, the antenna device 10 may be the antenna device 10 in any of the above embodiments. The antenna device 10 may also be the antenna device 10 in other embodiments. The present application is illustrated by taking the antenna device 10 provided by any of the above first embodiments as an example.

Alternatively, the housing 20 comprises a frame body 500, the frame body 500 encloses a hollow space 502, and the frame body 500 comprises a segmented portion 501, wherein the segmented portion 501 has a clearance hole 533 provided penetrating through, and the clearance hole 533 is configured to provide clearance for a plurality of antenna units 210.

In these optional embodiments, the frame body 500 of the housing 20 encloses a hollow space 502, so that components of the electronic apparatus can be provided in the hollow space 502. The segmented portion 501 of the frame body 500 comprises a clearance hole 533 provided penetrating through, and the clearance hole 533 can accommodate the plurality of antenna units 210. For example, when the antenna device 10 is the above-mentioned antenna device 10, the clearance hole 533 can accommodate the substrate 100. Since the clearance hole 533 penetrates through the segmented portion 501, a distance between the antenna unit 210 and the metal shielding layer 800 can be increased, thereby improving the wireless communication performance of the antenna device 10.

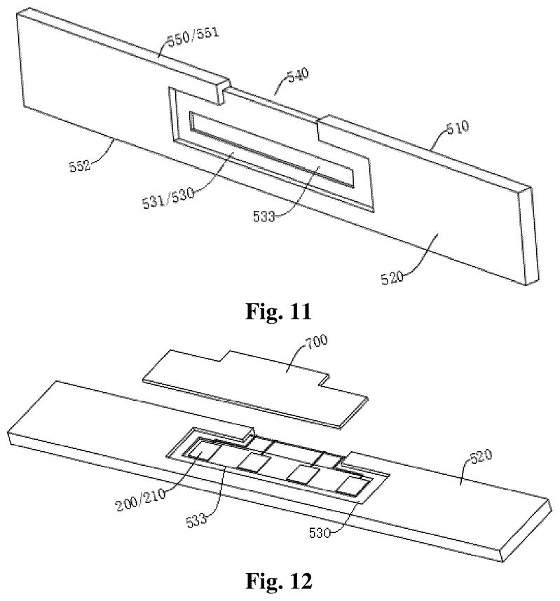

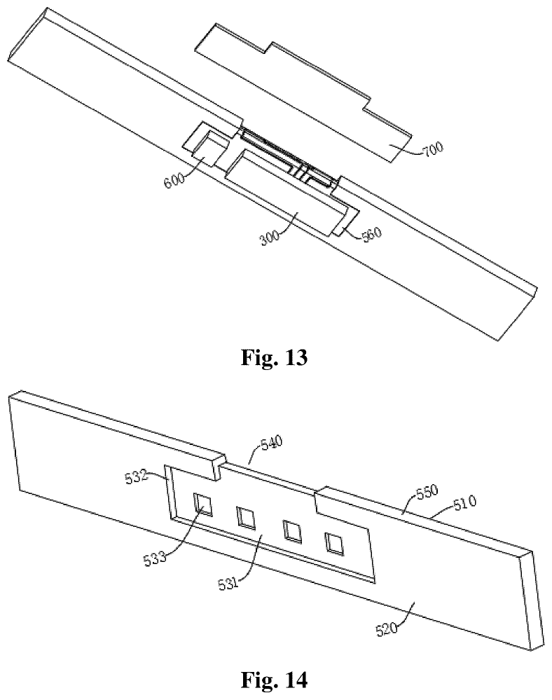

FIG. 10 is a structural schematic diagram of a frame of a housing 20 provided in an embodiment of the present application, FIG. 11 is a structural schematic diagram of a segmented portion 501 of a frame of a housing 20 provided in an embodiment of the present application, FIG. 12 is a structural schematic diagram when the antenna device 10 is provide on the segmented portion 501, and FIG. 13 is a structural schematic diagram when the antenna device 10 is provide on the segmented portion 501 from another viewing angle.

The frame body 500 may be a middle frame of the electronic apparatus. A material of the frame body 500 may comprise a metal material to improve the structural strength of the frame body 500. For example, the frame body 500 comprises a plurality of segmented portions 501, and the plurality of segmented portions 501 are connected end to end to enclose a hollow space 502. The plurality of segmented portions 501 comprise two first segmented portions spaced apart along a first direction Y and two second segmented portions spaced apart along a second direction X, and the two first segmented portions and the two second segmented portions are alternately enclosed to form a hollow portion.

There are many ways to provide the clearance hole 533. As shown in FIGS. 12 and 13, the clearance hole 533 is formed by extending along a spacing direction of the plurality of antenna units 210, and the same clearance hole 533 is configured to correspond to the plurality of antenna units 210. The plurality of antenna units 210 are provided corresponding to the same clearance hole 533, which can simplify the shape of the frame and the installation process of the plurality of antenna units 210, and improve the assembly efficiency of the antenna device 10.

Alternatively, when the antenna device 10 is provided in the first segmented portion, the plurality of antenna units 210 may be spaced apart along the second direction X, and the clearance hole 533 may be extended along the second direction X, where the second direction X is a length direction of the first segmented portion, that is, the length direction of the first section 110. When the antenna device 10 is provided in the second segmented portion, the plurality of antenna units 210 may be spaced apart along the first direction Y, and the clearance hole 533 may be extended along the first direction Y, where the first direction Y is a length direction of the second segmented portion, that is, the length direction of the first section 110.

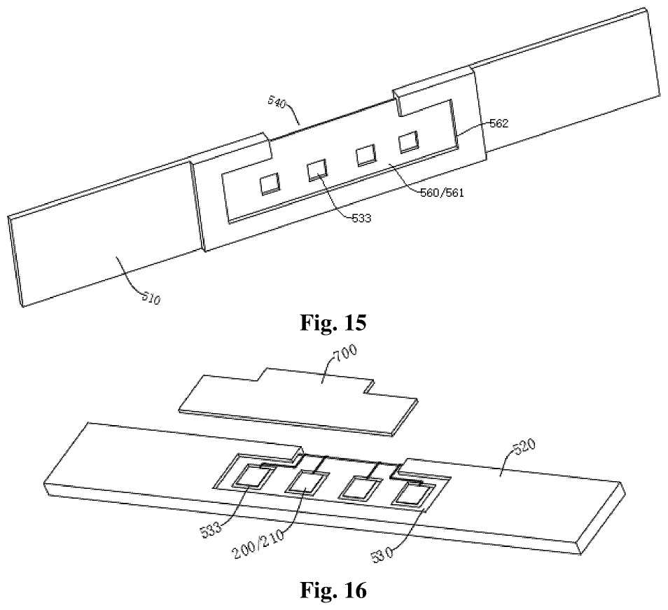

In another embodiment, as shown in FIGS. 14 to 16, a plurality of the clearance holes 533 are provided at intervals, and the clearance holes 533 each are configured to correspond to the antenna units 210, respectively. The plurality of clearance holes 533 are provided at intervals, which can improve the structural strength of the frame. Alternatively, the clearance holes 533 and the antenna units 210 are provided in one-to-one correspondence, so that each antenna unit 210 is correspondingly provided with a clearance hole 533.

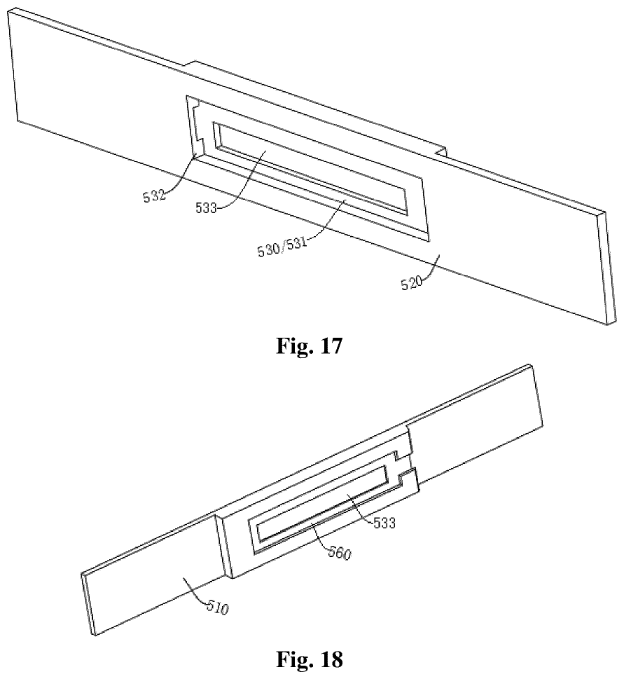

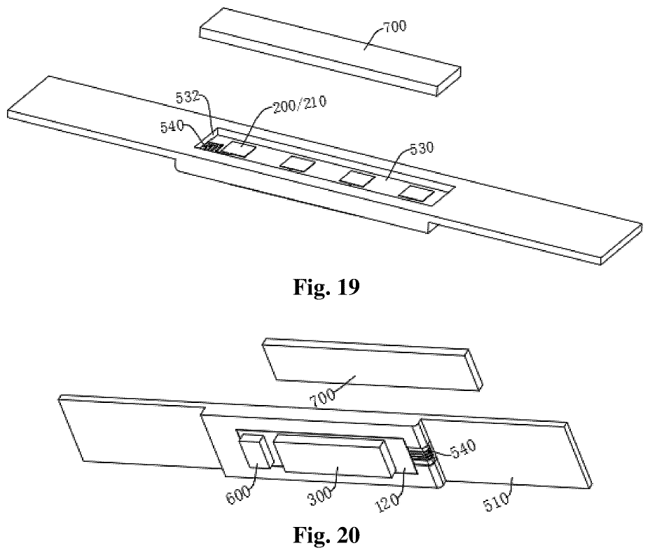

In some embodiments, as shown in FIGS. 17 to 20, the segmented portion 501 comprises an inner surface 510 facing the hollow space 502 and an outer surface 520 away from the hollow space 502, and the inner surface 510 or the outer surface 520 are recessed to form a first groove 530, and the clearance hole 533 is provided in the first groove 530.

In these embodiments, a first groove 530 is formed on a portion of the segmented portion 501 of the frame body 500, and the first groove 530 can accommodate a plurality of antenna units 210. For example, when the antenna device 10 is the above-mentioned antenna device 10, the first groove 530 can accommodate the substrate 100, and a plurality of the antenna units 210 are provided at intervals on the substrate 100. The plurality of antenna units 210 are accommodated in a same first groove 530, which can improve the installation process of the plurality of antenna units 210 and the assembly efficiency of the antenna device 10. The clearance hole 533 in the first groove 530 can be provided corresponding to a single or a plurality of antenna units 210.

In addition, by providing the first groove 530 on the inner surface 510 or the outer surface 520 of the segmented portion 501, it is possible to improve the problem that the outer surface 520 of the frame is uneven when the substrate 100 is directly provided on the surface of the segmented portion 501, and it is also possible to improve the problem that the substrate 100 is unstable and difficult to fix when it is directly provided in the clearance hole 533.

Optionally, the frame body 500 may be provided with a plurality of first grooves 530, each of which is configured to accommodate a plurality of antenna units. The plurality of first grooves 530 are provided at different positions of the frame body 500, so that the plurality of antenna module 200 will not be covered at the same time when the mobile terminal is in a horizontal screen, a vertical screen, etc. It can also reduce the blind area of wireless signals and achieve better communication quality.

The first groove 530 has a first bottom wall surface 531, and the clearance hole 533 is provide on the first bottom wall surface 531, and the size of the clearance hole 533 is smaller than the size of the first bottom wall surface 531, so that the substrate 100 can be in contact and connected with at least a portion of the first bottom wall surface 531 to improve the stability of the position of the substrate 100 and the first groove 530.

Alternatively, the inner surface 510 or the outer surface 520 is further recessed to form a second groove 560, and the second groove 560 is configured to accommodate the integrated circuit 300. The second groove 560 can provide limit for the integrated circuit 300 to ensure the stability of the position of the integrated circuit 300. For example, the second groove 560 is configured to accommodate the second section 120 and the integrated circuit 300 provided in the second section 120, the second groove 560 comprises a second bottom wall surface 561, and the second section 120 and the second bottom wall surface 561 are in contact and connected.

Alternatively, the clearance hole 533 penetrates through the first bottom wall surface 531 and the second bottom wall surface 561.

In some optional embodiments, as described above, when the first section 110 and the second section 120 of the substrate 100 are distributed at intervals, one of the first groove 530 and the second groove 560 can be provided on the outer surface 520, and the other can be provided on the inner surface 530. Or the first section 110 and the second section 120 can be provided on the inner surface 510 and the outer surface 520 respectively, so that one of the antenna unit 210 and the integrated circuit 300 is provided on the inner surface 510, and the other is provided on the outer surface 520.

In these embodiments, alternatively, the first groove 530 is located on the outer surface 520, the second groove 560 is located on the inner surface 510, the first section 110 may be located in the first groove 530, and the second section 120 may be located in the second groove 560, so that the antenna unit 210 is located on the outer surface 520, which can improve the effect of the frame blocking the antenna unit 210 and affecting its wireless signal transmission, and the integrated circuit 300 is located on the inner surface 510, so that the segmented portion 501 can provide protection for it.

Optionally, as described above, the first groove 530 has a first bottom wall surface 531, and the antenna unit 210 is provided on a side of the first section 110 away from the first bottom wall surface 531, so as to improve the shielding of the antenna unit 210 by the first section 110. Or, as described above, the second groove 560 has a second bottom wall surface 561, and the integrated circuit 300 is provided on a side of the second section 120 away from the second bottom wall surface 561. Optionally, when the first groove 530 is provided on the outer surface 520 and the second groove 560 is provided on the inner surface 510, there are a plurality of ways for the connecting portion 400 to connect the antenna unit 210 and the integrated circuit 300. As described above, the substrate may comprise a bent portion 130, and the connecting portion 400 may electrically connect the antenna unit 210 and the integrated circuit 300 via the bent portion 130.

In other embodiments, as shown in FIGS. 11 to 16, the segmented portion 501 comprises a channel 540 that penetrates through the inner surface 510 and the outer surface 520, the channel 540, the first groove 530 and the second groove 560 are communicated with each other.

In these optional embodiments, the segmented portion 501 further comprises a channel 540, which is communicated with the first groove 530, so that the connecting portion 400 can be connected with the antenna unit 210 located in the first groove 530 via the channel 540, thereby facilitating the electrical connection between the antenna unit 210 and the integrated circuit 300.

The channel 540 may be provided in various positions. For example, as shown in FIGS. 11 to 16, the segmented portion 501 further comprises a side surface 550 connecting the inner surface 510 and the outer surface 520, and the channel 540 may be formed by recessing of the side surface 550. When the substrate 100 comprises the first section 110, the second section 120, and the bent portion 130, the bent portion 130 may be located in the channel 540 to improve the problem that the bent portion 130 protrudes too high from the side surface 550.

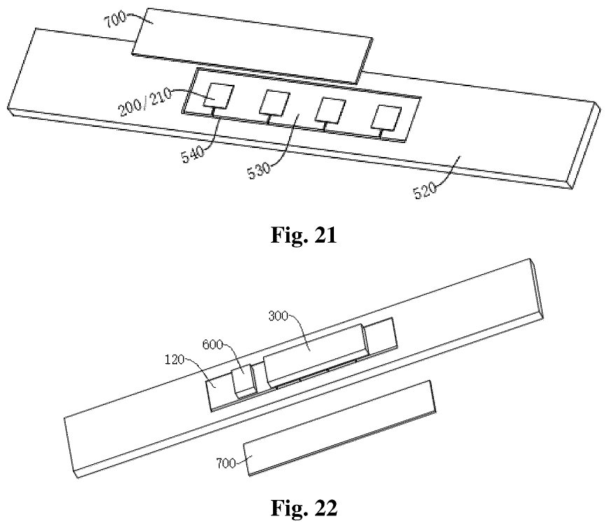

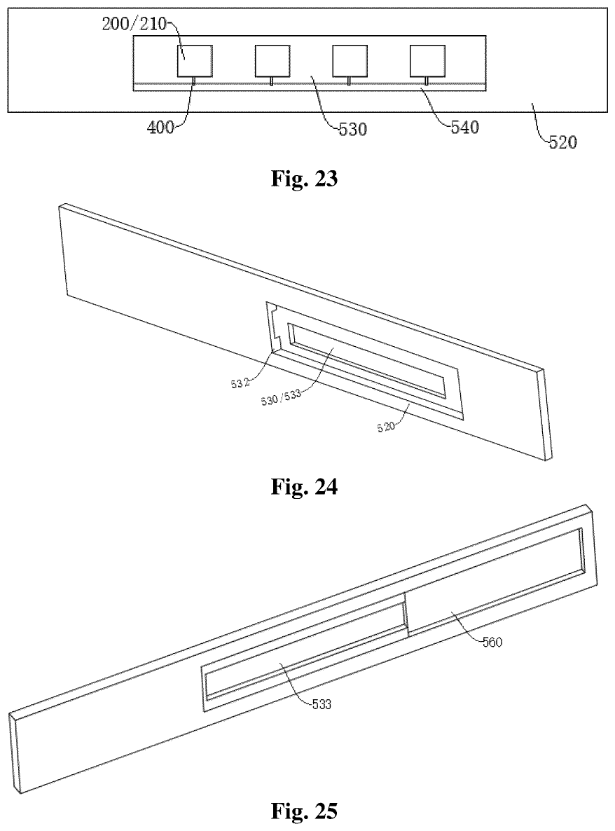

In other embodiments, as shown in FIGS. 17 to 23, the first groove 530 further comprises a first side wall surface 532 connected with the periphery of the first bottom wall surface 531, and the channel 540 is communicated with the first side wall surface 532 or the first bottom wall surface 531. When the substrate 100 comprises a first section 110 and a second section 120 that are separately provided, the first section 110 and the second section 120 can be separately provided on the inner surface 510 and the outer surface 520, and the connecting portion 400 connects the antenna unit 210 and the integrated circuit 300 via the channel 540 that is connected with the first side wall surface 532 or the first bottom wall surface 531.

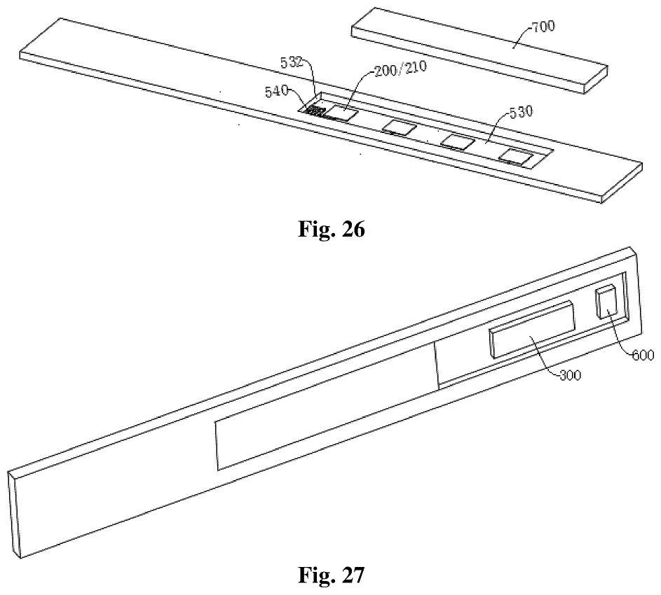

Alternatively, as described above, as shown in FIGS. 24 to 27, when the first section 110 and the second section 120 are provided side by side, the first groove 530 and the second groove 560 can both be provided on the inner surface 510, so that the antenna unit 210 and the integrated circuit 300 can both be protected by the segmented portion 501.

Alternatively, the housing 20 may further comprise a decorative cover 700, and the decorative cover 700 may be provided on the first groove 530. The decorative cover 700 may have the effects of being aesthetically pleasing, wear-resistant, waterproof, dust-proof, and anti-aging.

Alternatively, the material of the frame may comprise metal material to make the frame have sufficient structural strength. Alternatively, the material of the decorative cover 700 may comprise insulating material to improve the signal transmission of the antenna unit 210 in the first groove 530 when the decorative cover 700 is covered on the first groove 530.

Alternatively, the decorative cover 700 is covered on the first groove 530, the shapes of the decorative cover 700 and the first groove 530 match, the area and shape of the decorative cover 700 and the first bottom wall surface 531 are the same, and the decorative cover 700 and the first side wall 532 are in contact and connected with each other. Alternatively, when the first groove 530 is provide on the outer surface 520, the decorative cover 700 is align with the outer surface 520 to ensure the flatness of the outer surface 520 of the frame body 500. When the first groove 530 is provide on the inner surface 510, the decorative cover 700 can also be align with the inner surface 510.

As described above, when the channel 540 is communicated with the first side wall surface 532 or the first bottom wall surface 531, the shape of the housing 700 may not be irregular, so it is often more friendly to the aesthetic design of the appearance and the aesthetic taste of most consumers.

Optionally, the decorative cover 700 can further be covered on the second groove 560, and the shapes of the decorative cover 700 and the second groove 560 match. The second groove 560 comprises a second bottom wall surface 561 and a second side wall surface 562 connected with the periphery of the second bottom wall surface 561. The decorative cover 700 and the second bottom wall surface 561 have the same area and shape, and the decorative cover 700 and the second side wall surface 562 are in contact with each other. Optionally, when the second groove 560 is provide on the inner surface 510, the decorative cover 700 is align with the inner surface 510 to ensure the flatness of the inner surface 510 of the frame body 500. When the second groove 560 is provide on the outer surface 520, the decorative cover 700 can also be flush with the outer surface 520.

Optionally, when the antenna device 10 comprises a conductive isolation portion 140, a projection of the conductive isolation portion 140 along the thickness direction of the first section 110 and a projection of the clearance hole 533 along the thickness direction of the first section 110 are staggered. For example, the projection of the conductive isolation portion 140 along the first direction Y is located between the projections of two adjacent clearance holes 533 along the first direction Y Alternatively, when the conductive isolation portion 140 is provided on a side of the first section 110 facing the second section 120, the conductive isolation portion 140 located on the side of the first section 110 facing the second section 120 can be electrically connected with the segmented portion 501 to further improve isolation between the two adjacent antenna units 210, so as to achieve better antenna performance and better wireless communication quality.

An embodiment of a third aspect of the present application further provides an electronic apparatus, comprising the antenna device 10 of any of the above-mentioned embodiments of the first aspect and any of the above-mentioned housing 20 of the second aspect embodiments, wherein an orthographic projection of at least one of the antenna units 210 along the thickness direction of the first section 110 is located within an orthographic projection of the clearance hole 533 along the thickness direction of the first section 110.

As shown in FIGS. 1 to 27, the electronic apparatus in the embodiments of the present application comprise but are not limited to mobile phones, personal digital assistants (Personal Digital Assistant, referred to as: PDA), tablet computers, e-books, televisions, access control, smart fixed phones, consoles and other devices with display functions.

There are many ways to set the thickness direction of the first section 110. When the antenna device is provide in the first segmented portion, the thickness direction of the first section 110 can be the first direction Y When the antenna device is provide in the second segmented portion, the thickness direction of the first section 110 can be the second direction X.

Alternatively, the metal shielding layer 800 of the antenna device may be in contact with and connected with the segmented portion 501 to achieve grounding of the antenna device.

In these optional embodiments, the frame body 500 of the housing 20 encloses a hollow space 502, so that the components of the electronic apparatus can be provided in the hollow space 502. The segmented portion 501 of the frame body 500 comprises a clearance hole 533 provided penetrating through, and the clearance hole 533 can accommodate a plurality of antenna units 210. An orthographic projection of at least one antenna unit 210 along the thickness direction of the first section 110 is located within an orthographic projection of the clearance hole 533 along the thickness direction of the first section 110, which can increase the distance between the antenna unit 210 and the metal shielding layer 800, thereby improving the wireless communication performance of the antenna device 10.

In some optional embodiments, the plurality of antenna units 210 are provided at intervals along the length direction of the segmented portion 501, the clearance holes 533 are formed by extending along the length direction, and the orthographic projection of the plurality of antenna units 210 along the thickness direction of the first section 110 are located within the orthographic projections of the same clearance hole 533 along the thickness direction of the first section 110. The plurality of antenna units 210 are provided corresponding to a same clearance hole 533, which can simplify the shape of the frame and the installation process of the plurality of antenna units 210, and improve the assembly efficiency of the antenna device 10.

Alternatively, as described above, when the antenna device 10 is provided in the first segmented portion, the plurality of antenna units 210 may be distributed at intervals along the second direction X, the clearance holes 533 may be extended along the second direction X, and the second direction X is the length direction of the first segmented portion. When the antenna device 10 is provided in the second segmented portion, the plurality of antenna units 210 may be distributed at intervals along the first direction Y, the clearance holes 533 may be extended along the first direction Y, and the first direction Y is the length direction of the second segmented portion.

In another embodiment, a plurality of clearance holes 533 are provided at intervals, and the orthographic projection of each antenna unit 210 along the thickness direction of the first section 110 is located within the orthographic projection of each clearance hole 533 along the thickness direction of the first section 110. Moreover, each antenna unit 210 is provided corresponding to each clearance hole 533, which can improve the performance of the antenna unit 210 and the structural strength of the frame.

In some optional embodiments, as described above, the inner surface 510 and/or the outer surface 520 is recessed to form a first groove 530, the clearance hole 533 is provided in the first groove 530, and the first section 110 is located in the first groove 530. Thus, the plurality of antenna units 210 provided in the first section 110 can be located in a same first groove 530, thereby simplifying the installation of the antenna device 10.

In some optional embodiments, as described above, the housing 20 further comprises a second groove 560 formed by recessing of the inner surface 510, and the second section 120 is located in the second groove 560. The second groove 560 can provide limit for the integrated circuit 300 on the second section 120 to ensure the stability of the position of the integrated circuit 300.

Alternatively, the first groove 530 is provided on the outer surface 520, and the second section 120 is provided on the inner surface 510. So that the antenna unit 210 located in the first groove 530 is located on the outer surface 520, which can improve the effect of the frame blocking the antenna unit 210 and affecting the transmission of its wireless signal, and the integrated circuit 300 located in the second groove 560 is located on the inner surface 510, so that the segmented portion 501 can provide protection for it.

Alternatively, the segmented portion 501 comprises a channel 540 that penetrates through the inner surface 510 and the outer surface 520, the channel 540 and the first groove 530 are communicated with each other, and the connecting portion 400 electrically connects the antenna unit 210 and the integrated circuit 300 via the channel 540. The connecting portion 400 can be connected with the antenna unit 210 located in the first groove 530 via the channel 540, so as to facilitate the electrical connection between the antenna unit 210 and the integrated circuit 300.

Alternatively, the segmented portion 501 further comprises a first side surface 551 and a second side surface 552 connected the inner surface 510 and the outer surface 520 and provided opposite to each other, and the channel 540 is formed by recessing of the first side surface 551. A top surface of the connecting portion 400 away from the second side surface 552 is coplanar with the first side surface 551, or a top surface of the connecting portion 400 away from the second side surface 552 is located on a side of the first side surface 551 facing the second side surface 552. This improves the problem of the uneven side surface 550.

Alternatively, the antenna device 10 further comprises a connector 600 electrically connected with the integrated circuit 300, and the connector 600 and the integrated circuit 300 are both provided in the second section 120. This reduces the distance between the connector 600 and the integrated circuit 300, and facilitates the connection between the connector 600 and the integrated circuit 300. The integrated circuit 300 can be electrically connected with outside through the connector 600, for example, the integrated circuit 300 can be electrically connected with a mainboard of the electronic apparatus through the connector 600.

Alternatively, the plurality of antenna units 210 are distributed at intervals along the extension direction of the segmented portion 501, so that more antenna units 210 can be provided on the segmented portion 501. The extension direction of the segmented portion 501 is the length direction of the segmented portion 501.

Alternatively, the integrated circuit 300 and the connector 600 are distributed at intervals along the extension direction of the segmented portion 501. The segmented portion 501 has a larger size in its extension direction, which can leave more space for the integrated circuit 300 and the connector 600.

Alternatively, the first section 110 and the second section 120 are distributed in sequence along the length direction of the first section 110, the first groove 530 and the second groove 560 are both provided on the inner surface 510 and distributed in sequence along the length direction, a plurality of antenna units 210 are provided on a side of the first section 110 away from the hollow space 502 and exposed by the clearance hole 533, and the metal shielding layer 800 is provided on a side of the first section 110 facing the hollow space 502.

In these embodiments, the metal shielding layer 800 and the antenna unit 210 are respectively provided on two sides of the first section 110, which can increase the distance between the metal shielding layer 800 and the antenna unit 210 and improve the wireless communication performance of the antenna unit 210. The metal shielding layer 800 is located on the side of the first section 110 facing the hollow space 502, and the antenna unit 210 is located on the side of the first section 110 away from the hollow space 502, which can prevent the metal shielding layer 800 from shielding the antenna unit 210 and affecting its signal transmission.

Although the present application has been described with reference to preferred embodiments, various modifications may be made thereto and parts thereof may be replaced with equivalents without departing from the scope of the present application. In particular, the various technical features mentioned in the various embodiments may be combined in any manner as long as there are no structural conflicts. The present application is not limited to the specific embodiments disclosed herein, but comprises all technical solutions falling within the scope of the claims.

What is claimed is:

1. An antenna device, comprising:
a substrate, comprising a first section and a second section;
an antenna module, provided on the first section and comprising two or more antenna units distributed at intervals on the first section;
an integrated circuit, provided on the second section;
a connecting portion, provided on the substrate and electrically connecting the antenna units and the integrated circuit; and
a metal shielding layer, provided on the substrate, wherein orthographic projections of a plurality of the antenna units in a thickness direction of the first section are located within an orthographic projection of the metal shielding layer in the thickness direction.

2. The antenna device of claim 1, wherein the first section and the second section are distributed at intervals along the thickness direction, and the metal shielding layer is provided on the second section,
and the metal shielding layer and the integrated circuit are provided on two surfaces of the second section opposite to each other in the thickness direction, respectively.

3. The antenna device of claim 2, wherein the metal shielding layer is provided on a surface of the second section facing the first section, and the integrated circuit is provided on a surface of the second section away from the first section.

4. The antenna device of claim 1, wherein the first section and the second section are sequentially distributed along a length direction of the first section, and the metal shielding layer is provided on the first section; and
the antenna unit and the metal shielding layer are provided on two surfaces of the first section opposite to each other in the thickness direction, respectively.

5. The antenna device of claim 1, wherein the substrate further comprises a bent portion connecting the first section and the second section, the first section, the second section and the bent portion are integrally provided, one end of the connecting portion is connected with the antenna unit, and the other end of the connecting portion extending to the integrated circuit via the bent portion to electrically connect the antenna unit and the integrated circuit.

6. The antenna device of claim 1, wherein the first section and the second section are separately provided, and the connecting section comprises a first segment provided on the first section and electrically connected with the antenna unit, and a second segment provided on the second section and electrically connected with the integrated circuit, the first segment and the second segment are bound and connected, or the first segment and the second segment being electrically connected with each other via a connector.

7. The antenna device of claim 1, further comprising a conductive isolation portion provided in the first section and located between two adjacent ones of the antenna units,
the conductive isolation portion being provided on a surface of the first section, or the conductive isolation portion being provided on the first section;
the conductive isolation portion comprising a first isolation portion provided on a surface of the first section and a second isolation portion provided in the first section, the first isolation portion and the second isolation portion being connected with each other;
the first isolating portion being provided on two opposite surfaces of the first section, and the second isolating portion being connected with the first isolating portions located on the two opposite surfaces of the first section.

8. A housing of an electronic apparatus that comprises an antenna device including a plurality of antenna units, the housing comprising:
a frame body, enclosing a hollow space and comprising a segmented portion,
wherein the segmented portion comprises a clearance hole penetrating through the segmented portion, and the clearance hole is configured to provide clearance for the plurality of antenna units.

9. The housing according to claim 8, wherein
the clearance hole is formed by extending along the spacing direction of the plurality of antenna units, and clearance hole is configured to correspond to the plurality of antenna units.

10. The housing according to claim 8, wherein a plurality of the clearance holes are provided at intervals, and the clearance holes are configured to correspond to the antenna units, respectively.

11. The housing according to claim 8, wherein a plurality of the clearance holes are provided at intervals, and the clearance holes are provided in one-to-one correspondence with the antenna units.

12. The housing of claim 8, wherein the segmented portion comprises an inner surface facing the hollow space and an outer surface away from the hollow space, the inner surface or the outer surface are recessed to form a first groove, and the clearance hole is provided in the first groove, wherein
the inner surface or the outer surface are recessed to form a second groove configured to accommodate the integrated circuit of the antenna device;
one of the first groove and the second groove is provided on the outer surface, and the other is provided on the inner surface;
the first groove comprises a first bottom wall surface and a first side wall surface connected with a periphery of the first bottom wall surface, and the channel is communicated with the first side wall surface or the first bottom wall surface; and
the housing further comprises a decorative cover fitting on the first groove or the second groove.

13. The housing of claim 12, wherein the first groove is provided on the outer surface, the second groove is provided on the inner surface, the segmented portion comprises a channel penetrating through the inner surface and the outer surface, and the channel is communicated with the first groove and the second groove.

14. The housing of claim 12, wherein the first groove and the second groove are located on the inner surface.

15. The housing of claim 12, wherein the segmented portion further comprises a side surface connecting the inner surface and the outer surface, and the channel is formed by recessing the side surface.

16. An electronic apparatus, comprising:
a substrate, comprising a first section and a second section;
an antenna module, provided on the first section and comprising two or more antenna units distributed at intervals on the first section;
an integrated circuit, provided on the second section;
a connecting portion, provided on the substrate and electrically connecting the antenna units and the integrated circuit; and
a metal shielding layer, provided on the substrate, wherein orthographic projections of a plurality of the antenna units in a thickness direction of the first section are located within an orthographic projection of the metal shielding layer in the thickness direction;
a housing comprising:
a frame body, enclosing a hollow space and comprising a segmented portion,
wherein the segmented portion comprises a clearance hole penetrating through the segmented portion, and the clearance hole is configured to provide clearance for the plurality of antenna units;
wherein an orthographic projection of at least one of the antenna units along a thickness direction is located within an orthographic projection of the clearance hole along the thickness direction.

17. The electronic apparatus according to claim 16, wherein the plurality of antenna units are provided at intervals along the length direction of the segmented portion, the clearance hole is formed by extending along the length direction, and orthographic projections of the plurality of antenna units along the thickness direction are located within an orthographic projection of the same clearance hole along the thickness direction.

18. The electronic apparatus according to claim 16, wherein a plurality of the clearance holes are provided at intervals, and orthographic projections of the antenna units along the thickness direction are located within orthographic projections of the clearance holes along the thickness direction, respectively.

19. The electronic apparatus of claim 16, wherein the segmented portion comprises an inner surface facing the hollow space and an outer surface away from the hollow space, the inner surface or the outer surface are recessed to form a first groove, the clearance hole is provided in the first groove, and the first section is located in the first groove, wherein
the housing further comprises a second groove formed by recessing the inner surface, and the second section is located in the second groove;
the first groove has a first bottom wall surface, and the antenna unit is provided on a side of the first section away from the first bottom wall surface; or the second groove has a second bottom wall surface, and the integrated circuit is provided on a side of the second section away from the second bottom wall surface;
the segmented portion comprises a channel provided penetrating through the inner surface and the outer surface, the channel and the first groove are communicated with each other, and the connecting portion is electrically connected with the antenna unit and the integrated circuit via the channel;
the segmented portion further comprises a first side surface and a second side surface which are connected with the inner surface and the outer surface and are provided opposite to each other, the channel is formed by recessing the first side surface, a top surface of the connecting portion away from the second side surface is coplanar with the first side surface, or a top surface of the connecting portion away from the second side surface is located on a side of the first side surface facing the second side surface;
the antenna device further comprises a connector electrically connected with the integrated circuit, and the connector and the integrated circuit both are provided on the second section;
the plurality of antenna units are distributed at intervals along an extension direction of the segmented portion, or the integrated circuit and the connector are distributed at intervals along the extension direction of the segmented portion;
the first section and the second section are sequentially distributed along the length direction of the first section, the first groove and the second groove both are provided on the inner surface and sequentially distributed along the length direction, the plurality of antenna units are provided on a side of the first section away from the hollow space and exposed by the clearance hole, and the metal shielding layer is provided on a side of the first section facing the hollow space.

20. The electronic apparatus of claim 19, wherein the first groove is provided on the outer surface, and the second section is provided on the inner surface.
